(19) United States
(12) Patent Application Publication
(10) Pub. No.: US 2009/0094652 A1
(43) Pub. Date: Apr. 9, 2009

(54) Methods and Apparatus for Simultaneous Uploading and Streaming of Media

(75) Inventors: Mohammad Al Adham, Santa Clara, CA (US); Adil Lalani, Santa Clara, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: EatLime, Inc., Sunnyvale, CA (US)

(21) Appl. No.: 12/245,154

(22) Filed: Oct. 3, 2008

Related U.S. Application Data
(60) Provisional application No. 60/977,219, filed on Oct. 3, 2007.

(51) Int. Cl. H04N 7/173

(52) U.S. Cl. 725/103

(57) ABSTRACT

A method for a computer system includes receiving a request for a video file, determining whether the video file is currently being uploaded from a video source and stored in a memory, and when the video file is currently being uploaded, the method includes determining a size of the video file that is currently being uploaded, providing the size of the video file to a video consumer, retrieving a portion of the video file that is stored in the memory, and providing the portion of the video file to the video consumer, when the video file is not currently being uploaded, the method includes determining whether the video file is in the memory, and providing the video file to the video consumer if the video file is in the memory, wherein the video file is transcoded to an appropriate format prior to being uploaded.

### CROSS-REFERENCES TO RELATED APPLICATIONS

The present application claims priority to and incorporates by reference for all purposes Provisional No. 60/977,219, filed Oct. 3, 2007.

### BACKGROUND OF THE INVENTION

The present invention relates to simultaneous uploading and downloading of media, such as video data.

Video hosting and sharing sites have been gaining a lot of momentum on the Internet. These video websites typically operate by providing a hub between content up-loaders, and content viewers. The typical process of placing a video on a website can include the following steps:

1. A video uploader selects local video file on their machine to upload to video host;

2. Before any viewers can watch the video, the viewers have to wait for:
a. The video in an original, uncompressed format to be fully uploaded from the uploader's machine; thereafter
b. The uploaded video to be converted to another format, typical a format compatible with Adobe Flash players (this function typically uses the video hosting infrastructure of the hosting website); and
c. The uploaded video to be checked for copyright content, background checks for other illegal content, and the like (this function typically uses the video hosting infrastructure of the hosting website).

3. Finally, the viewers can watch the video being hosted on the video hosting site.

Drawbacks to such an approach include that a potential viewer of the video that is being uploaded, will not be able to view the video for quite a bit of time. Reasons for this include that uploading of a large video file e.g. 200 megabytes from a typical consumer internet connection e.g. max 384 kbps may take up to an hour. Another reason is that the video hosting web site often must perform the above processes, e.g. transcode, of the video, for a large number of videos, which may also take some time. Yet another reason is that due to the large number of videos to transcode, posting of the video in the target format may also take some time. Accordingly because, potential video viewers will lose the spontaneity in being able to view the video right away, that is highly prized for Internet transactions, viewers often do not bother “coming-back later.”

In light of the above, what is desired are methods and apparatus that address the issues discussed above.

### BRIEF SUMMARY OF THE INVENTION

The present invention relates to simultaneous uploading and downloading of media, such as video data.

The inventors of the present invention have recognized that sharing videos between sources and consumers has become popular on the Internet. Additionally, the inventors have recognized that video uploaders are important assets to video sharing websites because they provide new and fresh content for such video hosting sites. Because of this, the inventors believe it is important to provide such uploaders with tools that can facilitate the process of providing video to viewers, and that can result in more video views.

In one embodiment, a technique for processing videos includes:

1. an uploader selecting a local video file on their machine;

2. As the video is being uploaded, it is being transcoded or compressed to the Adobe Flash format on the uploader's machine, and also checked for illegal content; and

3. Viewers can immediately start watching the video as it is being uploaded to the video hosting site.

According to various embodiments, a method for a computer system is described. One technique includes receiving a request for a video file, and determining whether the video file is currently being uploaded from a video source and stored in a memory. A process includes, when the video file is currently being uploaded, determining a size (e.g. time, file size (e.g. bytes)) of the video file that is currently being uploaded, providing the size of the video file to a video consumer, retrieving a portion of the video file that is stored in the memory, and providing the portion of the video file to the video consumer. A method includes, when the video file is not currently being uploaded, determining whether the video file is in the memory, and providing the video file to the video consumer if the video file is in the memory. In various embodiments, the video file is transcoded to an appropriate format prior to being uploaded.

According to various embodiments, a computer system is described. One apparatus includes a memory configured to store a video file, and a processor coupled to the memory. In various devices the processor is configured to receive a request for the video file from a video consumer, and the processor is configured to determine whether the video file is currently being uploaded from a video source and stored in a memory. In various apparatus, the processor is configured to determine a size (e.g. time duration, file size) of the video file that is currently being uploaded, when the video file is currently being uploaded to the memory, the processor is configured to provide the size of the video file to the video consumer, when the video file is currently being uploaded to the memory, and the processor is configured to determine a size of the video file that is currently being uploaded, when the video file is currently being uploaded to the memory. In various systems, the processor is configured to retrieve a portion of the video file that is stored in the memory, when the video file is currently being uploaded to the memory, the processor is configured to provide the portion of the video file to the video consumer, when the video file is currently being uploaded to the memory, and the processor is configured to determine a size of the video file that is currently being uploaded, when the video file is currently being uploaded to the memory. In various apparatus the processor is configured to determine whether the video file is in the memory is complete, and the processor is configured to provide the video file to the video consumer when the video file is complete. In various embodiments, the video file is transcoded to an appropriate format prior to being uploaded.

According to various embodiments, a computer program product for a computer system including a processor and a memory comprising a computer-readable tangible media including executable computer code is described. The computer program product may include code configured to direct the processor to receive a request for a video file, code configured to direct the processor to determine whether the video file is currently being uploaded from a video source and stored in a memory, code configured to direct the processor to determine a size of the video file that is currently being uploaded, when the video file is currently being uploaded, and code configured to direct the processor to provide the size of the video file to a video consumer, when the video file is currently being uploaded. In various embodiments, the computer program product may include code configured to direct the processor to retrieve a portion of the video file that is stored in the memory, when the video file is currently being uploaded, code configured to direct the processor to provide the portion of the video file to the video consumer, when the video file is currently being uploaded, code configured to direct the processor to determine whether the video file is in the memory, when the video file is not currently being uploaded, and code configured to direct the processor to provide the video file to the video consumer if the video file is in the memory, when the video file is not currently being uploaded. In various embodiments, the computer-readable tangible media may be hard-disk drive or other magnetic memory, optical memory (e.g. DVD, CD-ROM), semiconductor memory (e.g. RAM, Flash-memory), or the like.

According to various embodiments, a method for a computer system is described. One technique includes sending a request to upload a video file to a video server, and before uploading any portions of the video file to the video server, receiving a computer network link from the video server in response to the request that indicates where the video file may be accessed from a computer network. A process may include receiving a video transcoder from the video server, wherein the video transcoder transcodes video into a format appropriate for the video server, and transcoding a first portion of the video file using the video transcoder to form a transcoded first portion of the video file. In various embodiments, while transcoding a second portion of the video file to form a transcoded second portion of the video file, uploading the transcoded first portion of the video file to the video server.

According to various embodiments, a computer program product for a computer system including a processor and a memory comprising a computer-readable tangible media including executable computer code, is disclosed. In various embodiments, the computer program product may include code configured to direct the processor to receive a video transcoder from a video server, wherein the video transcoder is configured to transcode a video file into a format appropriate for the video server, code configured to direct the processor to transcode a first portion of the video file and a second portion of the video file using the video transcoder to form a transcoded first portion of the video file and a transcoded second portion of the video file, and code configured to direct the processor to upload the transcoded first portion of the video file to the video server in parallel with the processor transcoding the second portion of the video file. In various embodiments, the computer-readable tangible media may be hard-disk drive or other magnetic memory, optical memory (e.g. DVD, CD-ROM), semiconductor memory (e.g. RAM, Flash-memory), or the like.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings.

FIG. 1 illustrates an overview diagram of a system according to various embodiments of the present invention;

FIGS. 2A-B illustrate a block diagram of a flowchart according to various embodiments of the present invention;

FIG. 3 illustrates a block diagram of a flowchart according to various embodiments of the present invention;

FIG. 4 illustrates a block diagram of a flowchart according to various embodiments of the present invention;

FIG. 5 illustrates a block diagram of a flowchart according to various embodiments of the present invention; and

FIG. 6 is a block diagram of typical computer system according to an embodiment of the present invention.

### DETAILED DESCRIPTION OF THE INVENTION

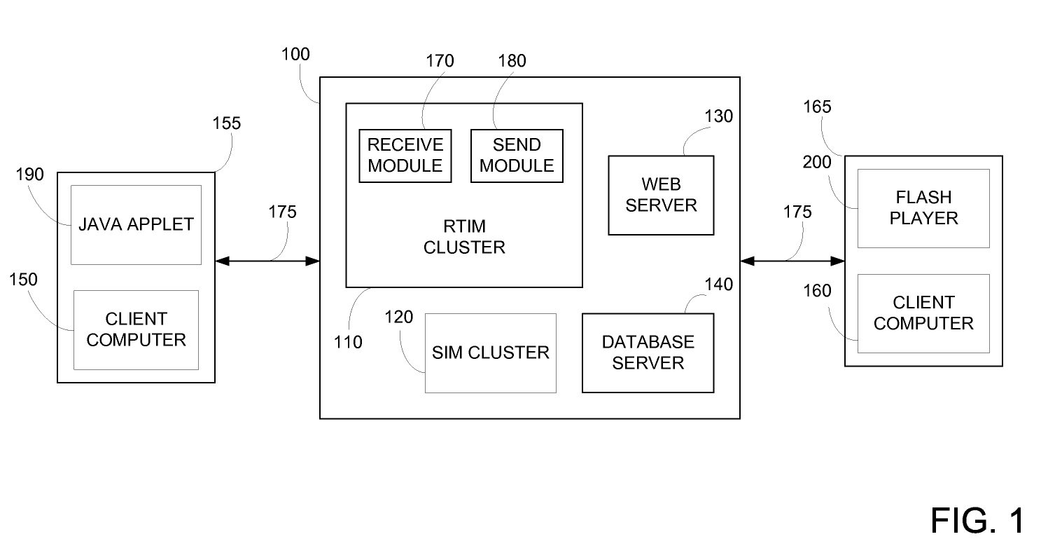

FIG. 1 illustrates an overview diagram of a system according to various embodiments of the present invention. More specifically, FIG. 1 illustrates a video upload source 155, a video server 100, and the video consumer 165 and computer networks 175 (e.g. Internet, wireless network, or the like). In one embodiment of the present invention video server 100 has been implemented by the assignee of the present invention, EatLime.

In various embodiments, video upload source 155 includes a computer system 150 coupled to video server 100 via a computer network 175. Computer system 150 typically includes software such as an internet browser as well as a runtime environment, e.g. Java runtime environment. In other embodiments of the present invention, other platform-specific (e.g. ActiveX) or any other platform-independent software may be used. In various embodiments, as will be described below, a Java applet 190, or the like, may be provided over computer network 175 for execution within the runtime environment.

In various embodiments, video consumer 165 includes a computer system 160 coupled to video server 100 via computer network 175. Computer system 160 typically includes software such as an internet browser and a video play-back program, e.g. Adobe Flash Player (possibly downloaded from video server 100). In other embodiments of the present invention, the video play-back program may any conventional/proprietary media player, such as Real Player, or the like.

As illustrated, video server 100 includes a web server 130, a database server 140, a video receiving module 170, a video sending module 180, a Real-Time Instant Media (RTIM) server 110, and a Static Instant Media (SIM) server 120.

In various embodiments of the present invention, web server 130 is used to receive requests for video data from video consumer 165. In various embodiments, the request from video consumer 165 may be made by a user clicking upon a video link in an e-mail program, a link on a web-site (e.g. blog, forum, chat), a link in a instant messaging program, a link in a “Twitter” or “tweet,” a link on an SMS, RSS, or the like. As will be described below, the video link may be sent to video consumer by a user of video upload source 155, a web page provided by web server 130, a web page provided by a third-party provider (e.g. Facebook, Youtube, MySpace), or the like.

In FIG. 1, a database server 140 is provided to maintain information regarding videos that are uploaded to video server 100, videos that are downloaded to video consumers 165, the status of video uploads, where videos are stored, and the like.

In various embodiments, RTIM server 110 may include a cluster of servers. In operation, RTIM server 110 is configured to receive (streaming) video content from video upload source 150. Additionally, while a video is being received, RTIM server 110 is configured to provide (streaming) video content to video consumers 165. In various embodiments, RTIM server 110 is a conventional file serving cluster.

SIM server 120 may also include a cluster of servers. In operation, SIM server 120 is configured to receive and store complete video content from video upload source 150. After a video has been completely uploaded, SIM server 120 is configured to provide (streaming) video content to video consumer 165. In various embodiments, SIM server 120 is a conventional file serving cluster.

In various embodiments of the present invention, receiving module 170 is provided to receive streaming video from video source 155, and provide the streaming video to RTIM server 110. Send module 180 is provided to retrieve video from RTIM server 110 or SIM server 120, and to provide streaming media (e.g. Flash video) to web server 130. In turn, web server 130 provides the streaming media to video consumer 165.

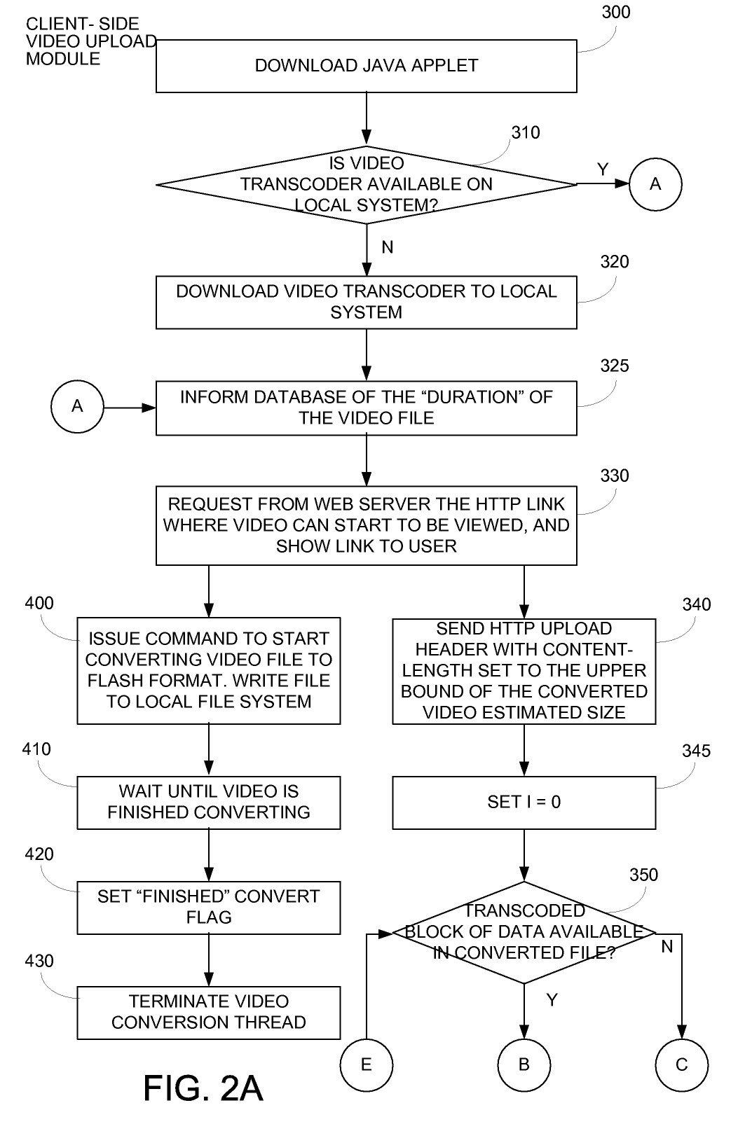

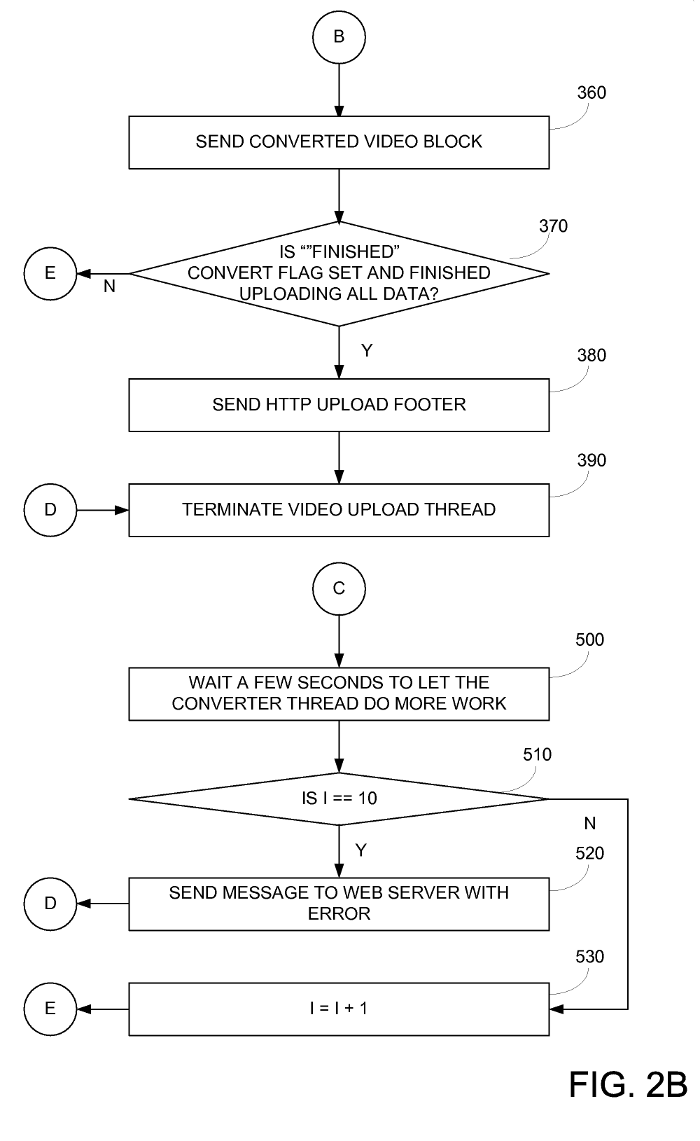

FIGS. 2A-B illustrate a block diagram of a flowchart according to various embodiments of the present invention. More specifically, FIGS. 2A-B illustrate an operational flow chart for the Java applet. In various embodiments of the present invention, the functions are packaged in the form of a Java Applet that is downloaded onto video source 155.

Initially, video source 155 connects with video server 100 via web server 130 to upload a video. In various embodiments of the present invention, in response web server 130 provides a download of Java code and Video Transcoder, step 300. As is known, the Java code will run within the browser as a Java Applet that is interpreted or compiled just-in-time. In other embodiments, the applet may be in the form of an ActiveX control, or the like. In various embodiments, the Video Transcoder is based upon an open-source executable file.

In operation, the applet initially checks if a video transcoder package has already been downloaded on video source 155. For example, a user at video source 155 may have previously uploaded videos to video server 100, and may already have previously downloaded a transcoder package, as further described below.

In various embodiments, if the transcoder package is not available, such as a first time video uploader, the transcoder package is downloaded from video server 100, step 320. In various embodiments of the present invention, the transcoder package may also be a Java applet with a video transcoder software.

As an initial step in an uploading process, a determination is made as to a playing-time of the video file to upload. This size (e.g. play duration, file size (e.g. bytes, Kbytes), is provided to video server 100, step 325. In various embodiments, the time duration refers to the playing-time, in terms of hours, minutes, seconds of the video, or the like; and the file size refers to number of bytes of the file, Kbytes of the file, physical storage size, or the like. In various embodiments, the size or duration is provided to video server 100 so video server 100 may quickly provide this information to video consumer 165.

Next, video server requests a unique network link, e.g. HTTP link, from video server 100 which will be associated and reserved for the video, even before the video is uploaded, step 330. In various embodiments of the present invention, in response to the request, video server 100 determines a unique HTTP link that will be used to store the video as it is being uploaded, and after it is fully uploaded. Any conventional method may be used to form a unique HTTP link, such as a hash of time data, an IP address of video source 155, or the like.

Once video server 100 determines the network link (e.g. HTTP link), video server 100 provides the network link to video source 155. In various embodiments of the present invention, a user at video source 155 may immediately provide this HTTP link to video consumer 165, e.g. friends, colleagues, or the like. In turn, video consumer 165 may immediately activate the network link (e.g. HTTP link.) and receive virtually as much of the video that has been uploaded to video server 100.

As illustrated in FIG. 2A, the following processes may next occur in parallel, to facilitate the uploading of video to video server 100. In various embodiments, these processes may be concurrently running processor threads, or the like.

In various embodiments, a first thread performs transcoding operations on the video file stored on video source 155. In various embodiments, the stored video file may be in virtually any conventional/proprietary video format, e.g. .wmv, .avi, .qt, .mov, .mpeg, .mpg, or the like. Further, the transcoding process may transcode the video data into any target conventional/proprietary streaming media format, such as Adobe Flash (.flv). In other embodiments, with appropriate modifications, other streaming media formats, such a RealMedia (.rm, .tram), Microsoft .asf, may also be supported.

In step 400, the transcoding process begins transcoding the video file stored on video source 155 to the target format, step 400. More specifically, the video file is incrementally read into memory, e.g. block by block, the block is transcoded, and the transcoded block is stored in a temporary file on video source 155. In various embodiments, the process is performed in streaming or pipelined manner, such blocks of the video file are read from memory at the same time transcoded blocks are stored to the temporary file.

In various embodiments of the present invention, the streaming transcoding continues until the transcoding process finishes, step 410. In response, a “finished” flag is typically set, step 420, and the video conversion process thread terminates, step 430. As will be discussed below, the finished flag is used in the second process thread to indicate completion of the transcoding process.

In various embodiments of the present invention, the second thread manages video uploading to video server 100, and executes in parallel with the video transcoding thread. In the embodiment shown, the process thread is used to simulate an HTTP upload from Java applet 190. In other embodiments of the present invention, other types of transfer protocol may be used.

More specifically, in various embodiments, an HTTP header is sent to video server 100, step 340. In the present example, a content-length (e.g. size) is included in the HTTP header. In cases where the converted flash video size can exactly be determined, the video size is the content-length. In other cases, an upper bound, or an estimate of the converted flash video size is the content-length. In various embodiments, the content-length is used to determine how long the upload connection should be open between video upload source 155 and video server 100 (e.g. receiving module Box 170, at step 660).

As merely an example of an HTTP header, the HTTP header conforms to the HTTP standard protocol and includes the following information:

===============================================
POST /spray-nozzle/im.php?file_guid=_guid HTTP/1.1

Accept: text/*

Content-Type: multipart/form-data;
boundary=----------_boundary
User-Agent: Shockwave Flash
Host: _host
Content-Length: _estimate
Pragma: no-cache
Connection: Close
------------_boundary
Content-Disposition: form-data; name=“Filename”
_name
------------_boundary
Content-Disposition: form-data; name=“Filedata”;
filename=“_name”
Content-Type: application/octet-stream
================================================
_guid: a unique identifier for the video file being uploaded.
_host: The IP address of the server (video server 100)
accepting the upload.
_estimate: the upper limit of the size of the uploaded file.

Because the size of the transcoded video file may be unknown, an
estimated upper limit may be very high, at about 2 GB or more.

_name: the name of the video file being uploaded.

In various embodiments, after the header is sent, transcoded video file is sent as it is being transcoded, steps 350-370. More specifically, the temporary file storing the transcoded video blocks are examined in a block-by-block fashion asynchronously, as video blocks are being written thereto in steps 400-430, described above. In various embodiments, each transcoded video block contains a certain amount of transcoded video data (e.g. kilobytes, megabytes, or the like).

As shown, when the trascoding process completes, and when there are no more transcoded video data blocks to uploaded to video server 100, and HTTP footer is sent, steps 370-380, and the uploading thread terminates, step 390. In the present example, the HTTP footer conforms to the HTTP standard protocol and includes the following information:

------------_boundary
Content-Disposition: form-data; name=“Upload”
Submit Query
------------_boundary—

In various embodiments of the present invention, when the video transcoding thread converts video at a slower pace than the video uploading thread is sending over the data, a delay loop is provided in the video uploading thread, steps 345, 500-530. More specifically, the video upload thread includes a delay loop to give the video transcoding thread a chance to convert and write more transcoded video data blocks into the temporary file. In case the video upload thread keeps waits beyond a threshold amount of time, without having transcoded video data available, an error condition is detected, and video server 100 is notified, step 520.

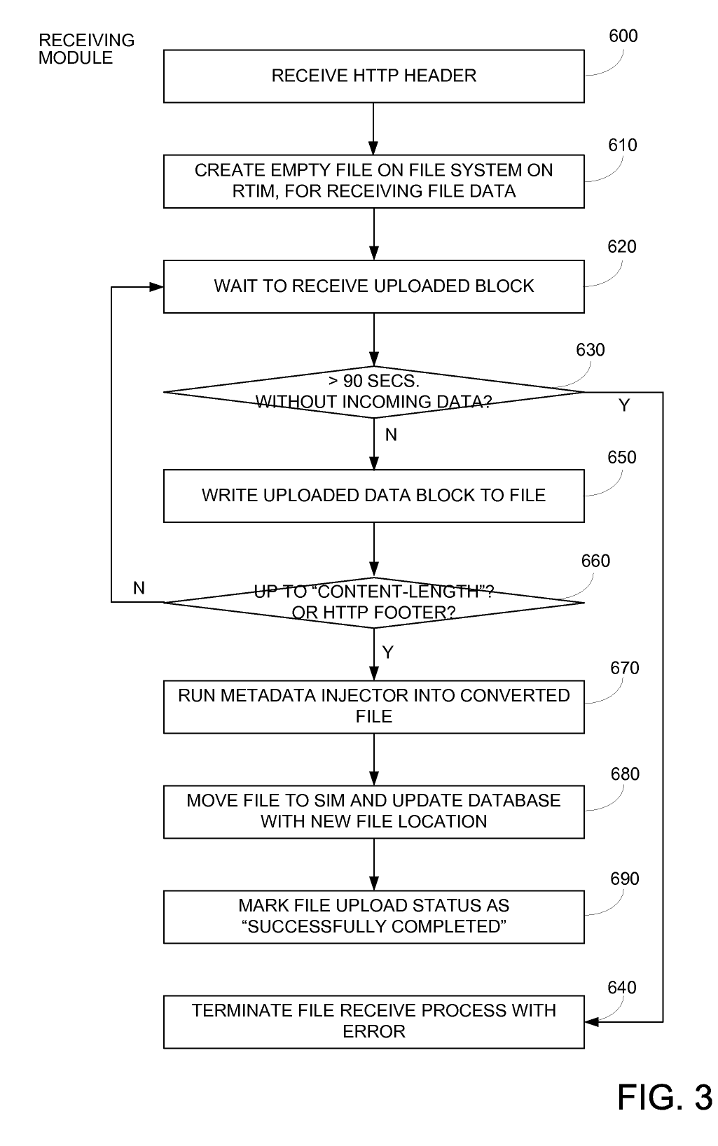

FIG. 3 illustrates a block diagram of a flowchart according to various embodiments of the present invention. More specifically, FIG. 3 illustrates an operational flow chart for receiving module 170.

In various embodiments, receiving module 170 is implemented in video server 100, and may be logically grouped within RTIM server 110. In operation, as discussed above, receiving module is configured to receive and process transcoded video data blocks being uploaded from video upload source 155.

Initially, receiving module 170 receives the HTTP header, formed above in step 340, from video upload source 155, step 600. In response, an upload file is created on the file system in RTIM server 110, step 610.

In various embodiments, receiving module 170 waits for transcoded video data blocks from video upload source 155, step 620. In the case that the module has to wait more than a configurable period of time, e.g. 90 seconds, without receiving an upload, receiving module terminates, step 640. Based upon the inventor's experience, 90 seconds is sufficiently long period of time to wait for data, after such a period of time, it is likely that connection to video upload source 155 has terminated, and, step 640.

In various embodiments of the present invention, as video data blocks are received, they are stored in the upload file, step 650. When the amount of file data uploaded is equal to the content-length that was sent in the HTTP header in step 340, or if the HTTP footer has been sent by video upload source 155 in step 380 or step 520, then the upload has finished, step 660.

In various embodiments, after the video upload (e.g. flash video file) has been completed, receiving module 170 runs an FLV metadata injector, step 670. In the present example, the purpose of the metadata injector is to provide “onMetaData” metadata information to the uploaded flash video file. In various embodiments, the MetaData injector is a software tool that appends to the Flash Video file information about the video itself, such as the actual playing duration or actual file size of the video, locations of the key-frames in the video, and such. For example, it allows user at the video consumer to be able to “jump around” during video play back.

As illustrated in FIG. 3, once the metadata is included in the (flash) video file, the (flash) video file is then moved to SIM server 120 for storage, and database 140 is updated with the new file location within SIM server 120, step 680. Finally, the flash video file is deleted from RTIM server 110, and the upload is marked as “successful,” step 690. As will be discussed below, the “successful” indication is used in Send Module 180, step 690.

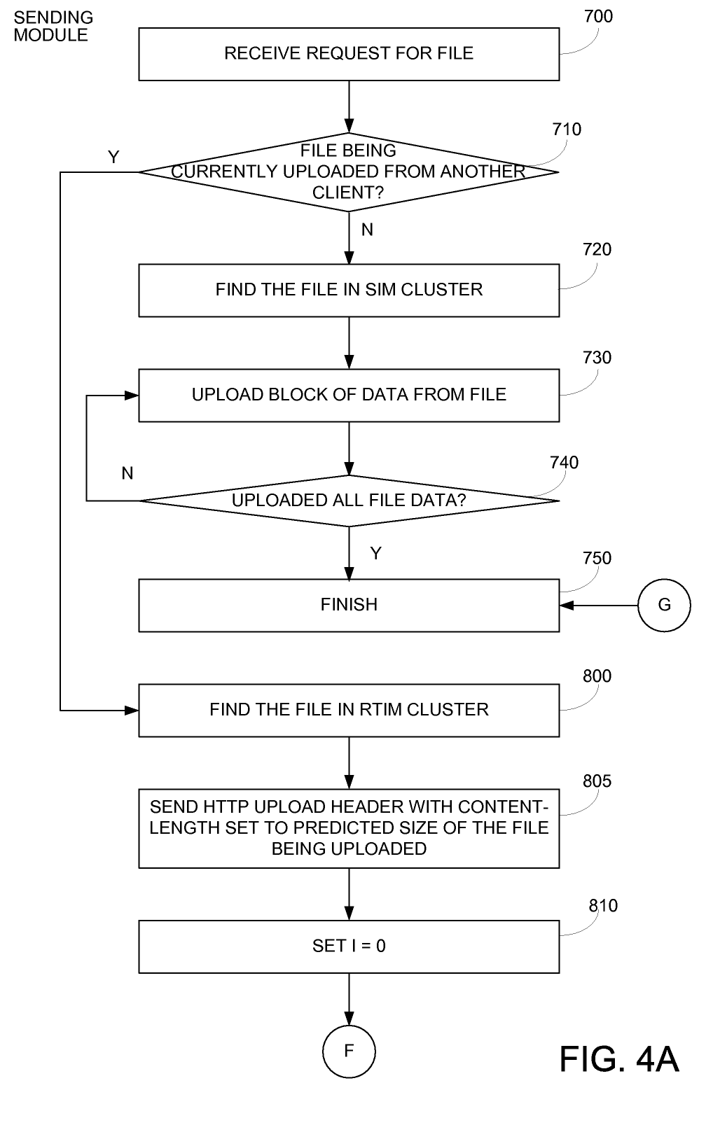

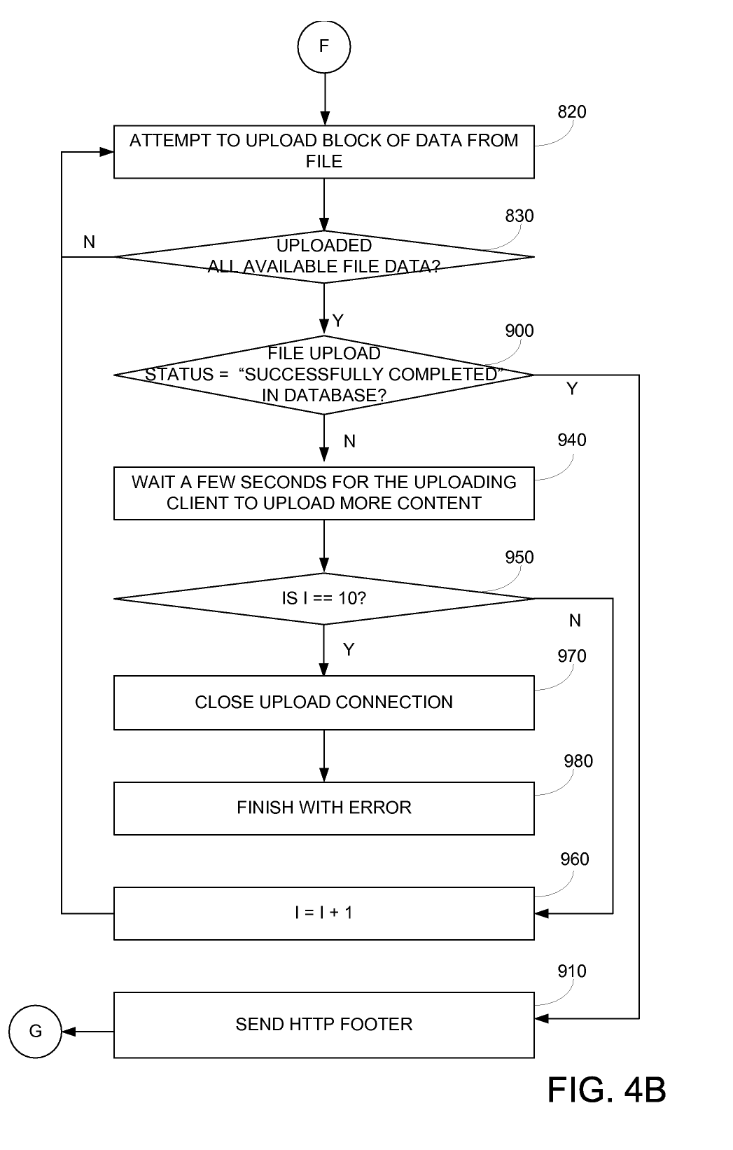

FIG. 4 illustrates a block diagram of a flowchart according to various embodiments of the present invention. More specifically, FIG. 4 illustrates an operational flow chart for sending module 180.

In various embodiments, sending module 180 is implemented in video server 100, and may be logically grouped within RTIM server 110. In operation, as discussed above, sending module 10 is configured to send uploaded video data (e.g. flash video file) to video consumer 165.

In various embodiments of the present invention, video consumer 165 is provided with the unique network link, e.g. HTTP link. As described above, in step 330, video consumer may be provided this unique network link in a variety of ways, such as from an e-mail message, instant message, short message service (SMS) from a user at video upload source 155; from a web page including the link from a third-party server (e.g. Facebook, MySpace); from a forum; from video server 100; from a RSS feed; from a Twitter “tweet;” or the like.

In some embodiments of the present invention, a user at video consumer 165 selects or activates the unique network link, step 700. As discussed above, this request for a video file (e.g. .flv file), may be made prior the video being fully uploaded into video server 100 from video upload source 155. In response to the request, sending module 180 initially determines whether the video file is currently being uploaded, step 710. In various embodiments of the present invention, database server 140 maintains the status of the video upload.

In various embodiments, if the file is not being currently uploaded from video upload source 155, it is interpreted to mean the video file has already been transferred from RTIM 110 to SIM server 120. Accordingly, the video file is then fetched and uploaded from SIM server 120, steps 720-750. More specifically, a determination is made as to whether the video file is resident in SIM server 120, step 720. Next, if so, a block of video data is retrieved from the video file and sent to video consumer 165, step 730. The process repeats until all blocks of video data have been sent to video consumer 165 (or if the connection with video player 200 is terminated), step 740, and then the connection terminates, step 750.

In various embodiments, if the file is being currently uploaded from video upload source 155, it is interpreted to mean the video file is still being uploaded and still being buffered in RTIM 110. As discussed above, this determination may be made based upon the HTTP header data that was discussed in step 340. More specifically, a determination may be made as to whether the portion of the video data that has been uploaded to RTIM 110 has reached the HTTP specified content-size. If the video file is still being uploaded, sending module 180 locates the requested incomplete video file within RTIM 110, step 800.

In various embodiments of the present invention, after locating the uploading video data, available video file blocks are then uploaded to video consumer 165, steps 820-830. More specifically, a video data block is located from the incomplete video file, and then downloaded to video consumer 165, step 820. The process then repeats until all available blocks of the requested video data stored in RTIM 110 have been sent to video consumer 165, step 830.

In various embodiments of the present invention, when the video uploading process from video upload source 155 occurs at a slower pace than the video downloading to video consumer 165, a delay loop is provided in sending module 180, steps 810, 940-960. Such situations may occur if video upload source 155 has a lower speed network connection than video consumer 165. For example, video upload source 155 may be a handheld device such as a 3G phone, iPhone, PDA, smartphone, or the like, and video consumer 165 may be a netbook, desktop computer, or the like.

When there is no further video data to upload to video consumer 165, database server 140 may indicate that video upload source 155 has successfully finished uploading the file, steps 830, 900-910.

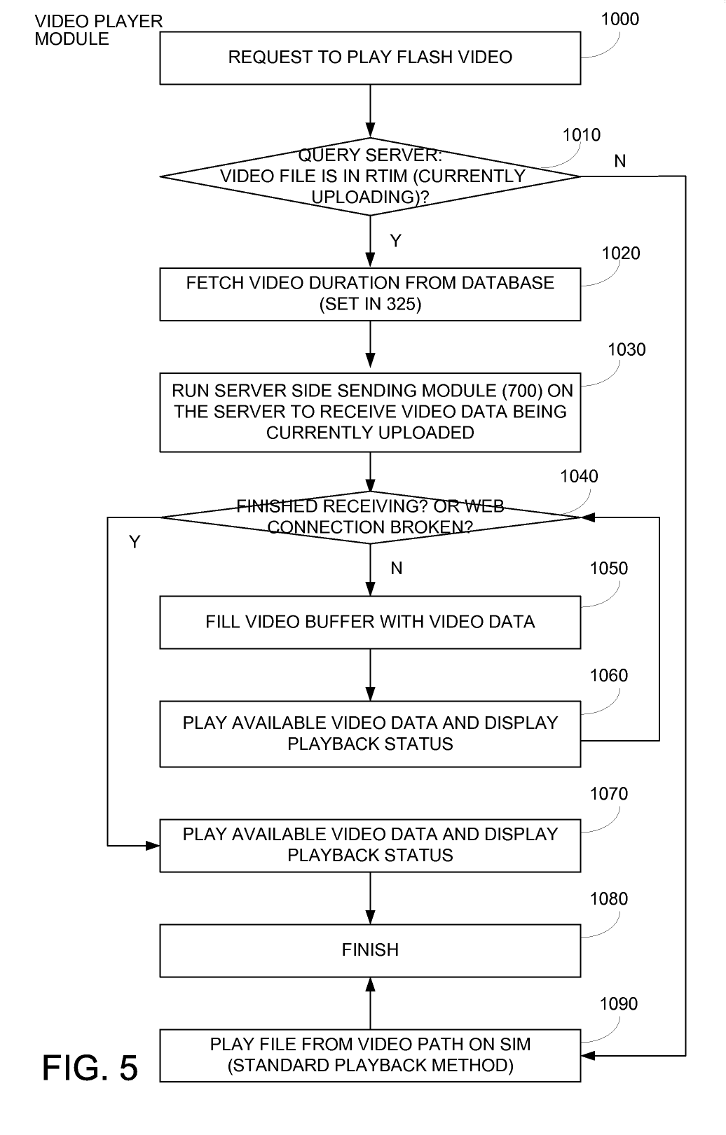

FIG. 5 illustrates a block diagram of a flowchart according to various embodiments of the present invention. More specifically, FIG. 5 illustrates an operational flow chart for video player 200 (e.g. Flash video player). In various embodiments, video player 200 includes additional functionality compared to a standard video player (e.g. standard Flash video player), as will be described below.

In various embodiments, when a user (e.g. a video viewer) requests to view a certain video file, step 1000, video player 200 queries video server 100 as to whether the video resides in RTIM server 110 or SIM 120, step 1010. In the case the video file resides in SIM server 120, video player 200 receives video data and using standard video play back functionality of the flash player, plays the video to the user, step 1090, until the user is finished, step 1080.

In various embodiments of the present invention, when it is determined that the video file is being uploaded and stored in RTIM server 110, the video playback functionality is different. More specifically, initially video duration or content-size of the uploading video is retrieved from Database server 140, step 1020. In various embodiments directed to Flash video, the content-size or duration is sent to video player 200 before the true duration or file size of the video file is known from the MetaData injector step 670. As discussed above, the MetaData is typically used by Flash players to display relevant information about the video.

Next, video player 200 directs sending module 700 to initialize and begin providing video data, step 1030. As discussed above, in FIGS. 4A-B, sending module 700 provides video data to video consumer 165 as it is buffered in RTIM server 110.

In various embodiments, while the video has not yet finished downloading, and while the web connection is maintained, step 1040, as data is received and buffered by video player 200, step 1050, the video is available for playback to a user, step 1060.

In various embodiments, when the video playback is complete, or the network connection is broken, step 1040, any buffered video remains available for playback to the user, step 1070. Subsequently, the user may terminate video player 200, by closing a browser or network session.

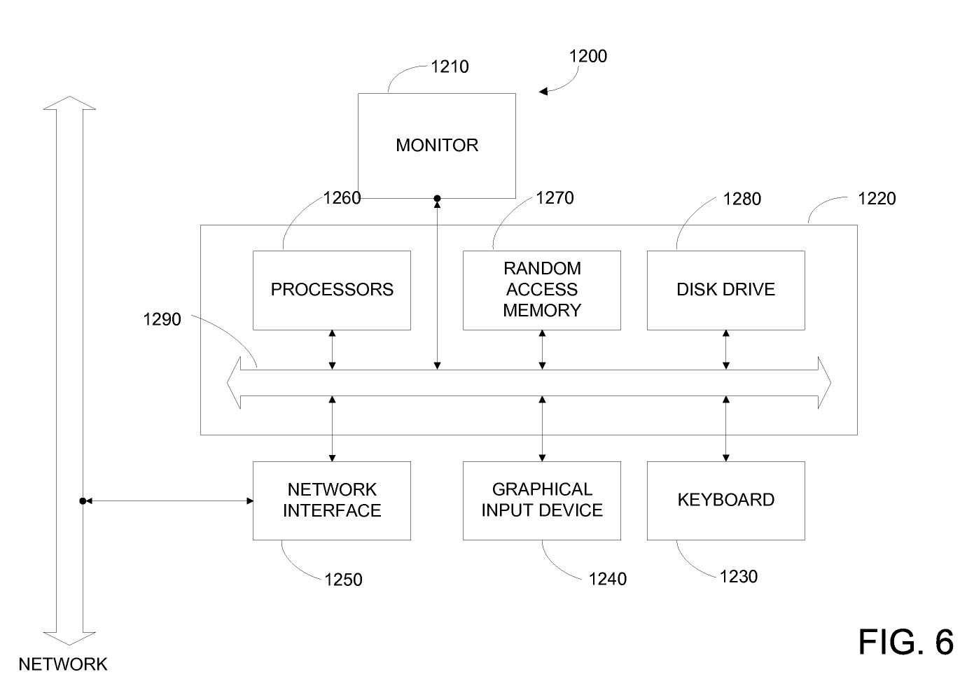

FIG. 6 is a block diagram of typical computer system 1200 according to an embodiment of the present invention. In the present embodiment, computer system 1200 typically includes a display 1210, computer 1220, a keyboard 1230, a user input device 1240, computer interfaces 1250, and the like.

In various embodiments, display (monitor) 1210 may be embodied as a CRT display, an LCD display, a plasma display, a direct-projection or rear-projection DIP, a micro display, or the like. In various embodiments, display 1210 may be used to visually display user interfaces, images, or the like.

In various embodiments, user input device 1240 is typically embodied as a computer mouse, a trackball, a track pad, a joystick, wireless remote, drawing tablet, voice command system, eye tracking system, and the like. User input device 1240 typically allows a user to select objects, icons, text and the like that appear on the display 1210 via a command such as a click of a button or the like. Embodiments of computer interfaces 1250 typically include an Ethernet card, a modem (telephone, satellite, cable, ISDN), (asynchronous) digital subscriber line (DSL) unit, FireWire interface, USB interface, and the like. For example, computer interfaces 1250 may be coupled to a computer network, to a FireWire bus, or the like. In other embodiments, computer interfaces 1250 may be physically integrated on the motherboard of computer 1220, may be a software program, such as soft DSL, or the like.

In various embodiments, computer 1220 typically includes familiar computer components such as a processor 1260, and memory storage devices, such as a random access memory (RAM) 1270, disk drives 1280, and system bus 1290 interconnecting the above components.

In some embodiments, computer 1220 includes one or more Xeon microprocessors from Intel. Further, in the present embodiment, computer 1220 typically includes a UNIX-based operating system. RAM 1270 and disk drive 1280 are examples of computer-readable tangible media configured to store embodiments of the present invention, such as computer-executable computer code, web servers, database servers, video data, receiving module, serving module, RTIM servers, SIM servers, or the like. The process described above may implemented as software routines on computer 1220. Types of tangible media include magnetic storage media such as floppy disks, networked hard disks, or removable hard disks; optical storage media such as CD-ROMS, DVDs, holographic memories; semiconductor media such as flash memories, read-only-memories (ROMS); battery-backed volatile memories; networked storage devices, and the like.

In the present embodiment, computer system 1200 may also include software that enables communications over a network such as the HTTP, TCP/IP, RTP/RTSP protocols, and the like. In alternative embodiments of the present invention, other communications software and transfer protocols may also be used, for example IPX, UDP or the like.

FIG. 6 representative of a computer system capable of embodying the present invention. It will be readily apparent to one of ordinary skill in the art that many other hardware and software configurations are suitable for use with the present invention. For example, the computer may be a desktop, portable, rack-mounted or tablet configuration. Additionally, the computer may be a series of networked computers, e.g. a separate database server, a separate web server, and the like. Further, the use of other micro processors are contemplated, such as Core™ microprocessors from Intel; Phnom™, Turion™64, Opteron™ microprocessors from Advanced Micro Devices, Inc; and the like. Further, other types of operating systems are contemplated, such as Windows Vista®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board.

In other embodiments of the present invention, any number of changes and additions to functionality are contemplated. For example, additional functionality in addition to transcoding may be performed in video upload source 155, such as copyright detection, or the like. In another example, the video to upload may be transcoded into more than one video file, e.g. high resolution (e.g. 640×480 PC resolution) and low resolution video (e.g. iPod resolution 320×240), high bit rate and low bit rate video, and the like. In other embodiments, other types of media data can be transferred than just video data, for example, .mp3 data, MJPEG data, and the like.

In other embodiments, video upload source 155 and video consumer 165 may be embodied in the form of any computing platform, such as a handheld device (e.g. iPhone, iTouch, PDA, smart phone, or the like), a computer (e.g. laptop, netbook, desktop, or the like), or other device.

Still further, in other embodiments, where Java applets are not used, a generic sender module may be used in upload source 155, and generic receiver module may be used in consumer 165. Such embodiments would enable parties to simulate sending content from one party to another as though the sending was a peer-to-peer transmission. For instance, during a web conference, one party might want to share a file with another party. With embodiments of the present invention, using a client-server model, a file can begin to be retrieved while the file is being uploaded to server 100, in real-time.

In other embodiments of the present invention, combinations or sub-combinations of the above disclosed invention can be advantageously made. The block diagrams of the architecture and graphical user interfaces are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method for a computer system comprising:
receiving a request for a video file;
determining whether the video file is currently being uploaded from a video source and stored in a memory;
when the video file is currently being uploaded, the method includes:
determining a size of the video file that is currently being uploaded;
providing the size of the video file to a video consumer;
retrieving a portion of the video file that is stored in the memory; and
providing the portion of the video file to the video consumer;
when the video file is not currently being uploaded, the method includes:
determining whether the video file is in the memory; and
providing the video file to the video consumer if the video file is in the memory;
wherein the video file is transcoded to an appropriate format prior to being uploaded.

2. The method of claim 1 wherein providing the size of the video file to a video consumer comprises sending an HTTP upload header comprising the size of the video file.

3. The method of claim 2
wherein the video consumer comprises a video player program; and
wherein the video player program receives the size of the video file.

4. The method of claim 1 further comprising:
receiving a request to upload the video file from the video source;
providing the video source with a video transcoder, wherein the video transcoder is configured to transcode a source video into the video file of the appropriate format; and
storing portions of the video file in the memory as the portions of the video file are uploaded from the video source.

5. The method of claim 4 wherein the appropriate format comprises an Adobe Flash format.

6. A computer system comprising:
a memory configured to store a video file; and
a processor coupled to the memory,
where in the processor is configured to receive a request for the video file from a video consumer,
wherein the processor is configured to determine whether the video file is currently being uploaded from a video source and stored in a memory,
wherein the processor is configured to determine a size of the video file that is currently being uploaded, when the video file is currently being uploaded to the memory;
wherein the processor is configured to provide the size of the video file to the video consumer, when the video file is currently being uploaded to the memory;
wherein the processor is configured to determine a size of the video file that is currently being uploaded, when the video file is currently being uploaded to the memory;
wherein the processor is configured to retrieve a portion of the video file that is stored in the memory, when the video file is currently being uploaded to the memory;
wherein the processor is configured to provide the portion of the video file to the video consumer, when the video file is currently being uploaded to the memory;
wherein the processor is configured to determine a size of the video file that is currently being uploaded, when the video file is currently being uploaded to the memory;
wherein the processor is configured to determine whether the video file is in the memory is complete; and
wherein the processor is configured to provide the video file to the video consumer when the video file is complete.
wherein the video file is transcoded to an appropriate format prior to being uploaded.

7. The computer system of claim 6
wherein the processor is configured to receive a request to upload the video file from a video source;
wherein the processor is configured to provide the video source with a video transcoder, wherein the video transcoder is configured to transcode a source video into the video file of the appropriate format;
wherein the processor is configured to store portions of the video file in the memory as the portions of the video file are uploaded from the video source.

8. The computer system of claim 7
wherein before the portions of the video file are uploaded to the memory, the processor is configured to determine a computer network link associated with the video file in the memory.

9. The computer system of claim 8 wherein the appropriate format comprises an Adobe Flash format.

10. A computer program product for a computer system including a processor and a memory comprising a computer-readable tangible media including executable computer code, the computer program product comprising:
code configured to direct the processor to receive a request for a video file;
code configured to direct the processor to determine whether the video file is currently being uploaded from a video source and stored in a memory;
code configured to direct the processor to determine a size of the video file that is currently being uploaded, when the video file is currently being uploaded;
code configured to direct the processor to provide the size of the video file to a video consumer, when the video file is currently being uploaded;
code configured to direct the processor to retrieve a portion of the video file that is stored in the memory, when the video file is currently being uploaded;
code configured to direct the processor to provide the portion of the video file to the video consumer, when the video file is currently being uploaded;
code configured to direct the processor to determine whether the video file is in the memory, when the video file is not currently being uploaded; and
code configured to direct the processor to provide the video file to the video consumer if the video file is in the memory, when the video file is not currently being uploaded.

11. The computer program product of claim 10 further comprising code configured to direct the processor to send an HTTP upload header comprising the size of the video file.

12. The computer program product of claim 10 further comprising:
code configured to direct the processor to receive a request to upload the video file from the video source;
code configured to direct the processor to provide the video source with a video transcoder, wherein the video transcoder is configured to transcode a source video into the video file; and
code configured to direct the processor to store portions of the video file in the memory as the portions of the video file are uploaded from the video source.

13. The computer program product of claim 10 further comprising code configured to direct the processor to determine a computer network link associated with the video file in the memory, before the portions of the video file are uploaded to the memory.

14. The computer program product of claim 10 further comprising code configured to direct the processor to provide the computer network link to the video consumer.

15. A method for a computer system comprises:
sending a request to upload a video file to a video server;
before uploading any portions of the video file to the video server, receiving a computer network link from the video server in response to the request that indicates where the video file may be accessed from a computer network;
receiving a video transcoder from the video server, wherein the video transcoder transcodes video into a format appropriate for the video server;
transcoding a first portion of the video file using the video transcoder to form a transcoded first portion of the video file; and
while transcoding a second portion of the video file to form a transcoded second portion of the video file, uploading the transcoded first portion of the video file to the video server.

16. The method of claim 15 further comprising:
sending the computer network link to a video consumer in a message selected from a group consisting: an e-mail message, an instant message, a web page.

17. The method of claim 16 wherein the format comprises an Adobe Flash format.

18. The method of claim 17 further comprising before uploading any portions of the video file to the video server, sending a video size of the video file to the video server.

19. A computer program product for a computer system including a processor and a memory comprising a computer-readable tangible media including executable computer code, the computer program product comprising:
code configured to direct the processor to receive a video transcoder from a video server, wherein the video transcoder is configured to transcode a video file into a format appropriate for the video server;
code configured to direct the processor to transcode a first portion of the video file and a second portion of the video file using the video transcoder to form a transcoded first portion of the video file and a transcoded second portion of the video file; and
code configured to direct the processor to upload the transcoded first portion of the video file to the video server in parallel with the processor transcoding the second portion of the video file.

20. The computer program product of claim of claim 19 wherein the transcoded first portion of the video file comprises an Adobe Flash format.
